(19) United States
(12) Patent Application Publication
(10) Pub. No.: US 2006/0207919 A1
(43) Pub. Date: Sep. 21, 2006

(54) Effluent interceptor with solids removal

(76) Inventor: Ronghua Zhou, Las Vegas, NV (US)

Correspondence Address: CALFEE HALTER & GRISWOLD, LLP, 800 SUPERIOR AVENUE, SUITE 1400, CLEVELAND, OH, 44114, US

(21) Appl. No.: 11/082,643

(22) Filed: Mar. 17, 2005

(51) Int. Cl. B01D 17/00

(52) U.S. Cl. 210/86; 210/91; 210/104; 210/519; 210/521; 210/112; 210/114

(57) ABSTRACT

An interceptor has an inlet chamber and a solids removing chamber disposed above the inlet chamber. A pump in the inlet chamber pumps effluent though a conduit to the solids removing chamber. A disposable filter at the end of the conduit catches any solids as the effluent passes therethrough. A drain is provided in the solids removing chamber to allow the filtered effluent to return to the inlet chamber. As a result, the filter is kept in a dry place, thus making it easier to change.

### BACKGROUND

It is known to pass an effluent from food processing facilities or other operations through devices for removing waste, such as grease, to enable the waste to be kept out of a sewage system. Examples of such devices are shown in U.S. Pat. Nos. 5,705,055, 6,423,213, and 6,776,900. Some of these devices work by pumping out grease or oil floating on the surface of a body of water, using an external pump which collects the grease or oil and deposits it elsewhere.

In order to remove solids from the effluent, some devices place a filter over an inlet pipe to catch the solids as the effluent passes through the inlet pipe. In these devices, the filter remains disposed in a constant stream or pool of effluent which makes the filter soggy and less desirable to be changed. Due to the messy nature of changing a filter that is sitting in a stream or pool of effluent, many users do not change the filter as often as recommended.

### SUMMARY

In accordance with one aspect of the invention, an interceptor is provided having an inlet chamber and a solids removing chamber disposed above the inlet chamber. A pump in the inlet chamber pumps effluent though a conduit to the solids removing chamber. A filter at the end of the conduit catches any solids as the effluent passes therethrough. A drain is provided in the solids removing chamber to allow the filtered effluent to return to the inlet chamber. As a result, the filter is kept in a dry place thus allowing a user to change a dry, less disgusting filter.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention as well as embodiments and advantages thereof are described below in greater detail, by way of example, with reference to the drawings in which:

FIG. 1 is a cross-sectional view of an interceptor;

FIG. 2 is a cross-sectional view of the solids removing chamber of the interceptor of FIG. 1 in an unfilled state;

FIG. 3 is a cross-sectional view of the solids removing chamber of the interceptor of FIG. 1 in a filled state;

FIG. 4 is a cross-sectional side view of the dam of the interceptor of FIG. 1;

FIG. 5 is a front cross-sectional view of the dam of the interceptor of FIG. 1; and

FIG. 6 is a perspective view of the dam of the interceptor of FIG. 1.

### DETAILED DESCRIPTION

While this invention is susceptible of embodiment in many different forms, there are shown in the drawings and will be described herein in detail specific embodiments thereof with the understanding that the present disclosure is to be considered as an exemplification of the principles of the invention and is not intended to limit the invention to the specific embodiments illustrated.

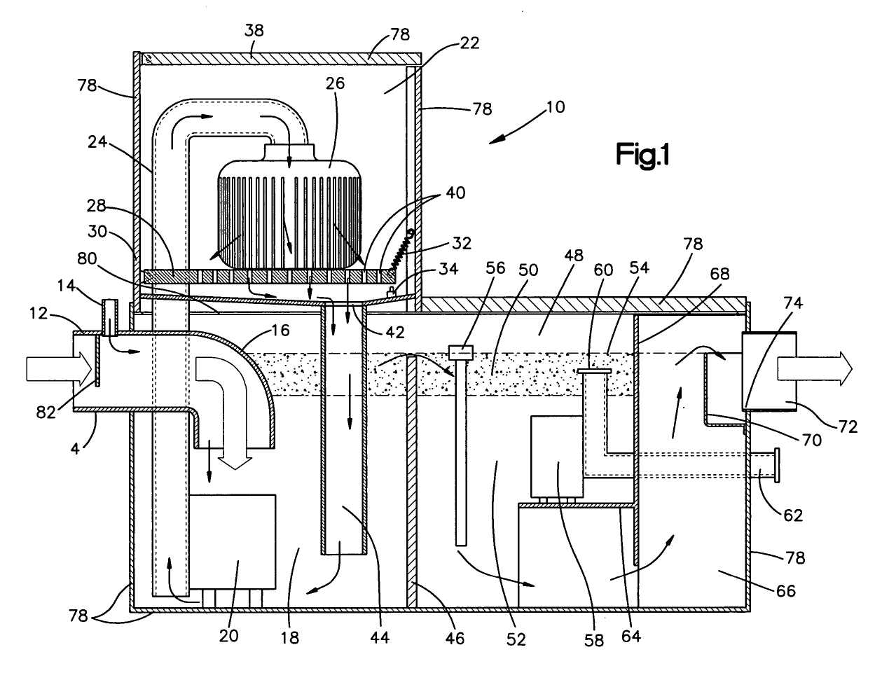

FIG. 1 illustrates an interceptor 10 that is a first embodiment of the present invention. The interceptor 10 includes a plurality of exterior walls 78, an inlet pipe 12 and an outlet 72. The size, shape and material used to construct the interceptor 10 may vary from the illustrated embodiment. The inlet pipe 12 includes a vent 14 to introduce air into the effluent as it enters the interceptor 10. Additionally, the inlet pipe 12 includes a flow restrictor 82 to limit the flow rate of the effluent entering the interceptor 10. The reduced flow rate prevent excess turbulence in the effluent and as a result, helps the separation process.

In the interior of the interceptor 10 there is located a first baffle 46 which, along with the exterior walls 78 and the upper wall 80, defines an inlet chamber 18. A first pump 20 is positioned in one lower corner of the inlet chamber 18. The first pump 20 as illustrated is a sump pump but may be another type of pump. The first pump 20 has an outlet which connects to a conduit 24 that terminates in a solids removing chamber 22.

The interceptor 10 also includes a drain duct 44 located in the inlet chamber 18 at a diagonally opposite corner from the first pump 20. The location of the drain duct 44 within the inlet chamber 18 may vary.

As shown in FIG. 1, the top of the first baffle 46 is below a static level 54. The static level 54 is the highest level that the effluent will reach at equilibrium when the interceptor is at maximum capacity. The first baffle 46 may extend above the static level 54 and have openings below the static level 54 in order to allow effluent to flow therethrough.

Above the inlet chamber 18 is the solids removing chamber 22. In the illustrated embodiment, the solids removing chamber 22 is directly above the inlet chamber 18. The solids removing chamber 22 does not have to be directly above the inlet chamber 18. For example, the solids removing chamber 18 may be offset horizontally from the inlet chamber 18, so long as the force of gravity can return filtered effluent to the inlet chamber 18. A pump may also be used to help return the filtered effluent to the inlet chamber 18 if the solids removing chamber 22 is not directly above the inlet chamber 18.

The solids removing chamber 22 includes a lid 38 which opens to allow access to the chamber 22. As shown in FIG. 1, the lid 38 may be hinged at one end. The attachment of the lid 38 is not critical so long as it provides access to the chamber 22 from the exterior. The interceptor 10 also includes a filter 26 disposed at the end of the conduit 24 in the solids removing chamber 22. The filter 26 may be a disposable, easily changed, porous pliable bag which catches solids in the effluent but still allows the effluent (absent solids) to pass therethrough.

The filter 26 sits above, and, when filled, on, a platform 28. The platform 28 is hinged at one end and attached to a spring 32 at the other end. The hinge is attached to a sidewall 30 of the solids removing chamber 22 and the spring 32 is attached to the interior side of the exterior wall 78. This arrangement allows the platform 28 to pivot downwardly as the weight from the filter 26 pushes against the platform.

Below the platform 28 is a switch 34. When the weight of the filter 26 is great enough, the platform 28 pivots down far enough to contact the switch 34 which in turn activates an alarm 36 as described below. This mechanical arrangement may be replaced by other arrangements which sense the fullness of the filter 26 and provide an indication of when the filter 26 needs to be replaced.

The platform 28 includes a plurality of holes 40 which allow filtered effluent to pass through the platform 28. The passing of the filtered effluent may also be accomplished in many other ways. For example, the platform 28 may be sized smaller than the footprint of the solids removing chamber 22 which would then permit filtered effluent to run over the edges of the platform 28. Below the platform 28 is a drain 42. The drain 42 provides a passage for the filtered effluent to return to the inlet chamber 18. In the illustrated embodiment, the drain 42 includes and is attached to the drain duct 44. In this manner, filtered effluent can be directed to a specific location within the inlet chamber 18.

The first baffle 46 separates the inlet chamber 28 from an effluent separation chamber 48. The effluent separation chamber 48 is defined by the first baffle 46, a second baffle 68, and the exterior walls 78. Located in the effluent separation chamber 48 is a second pump 58. In the illustrated embodiment, the second pump 58 is an inverted submersible pump with its inlet 60 directed upward. By being submersible, the second pump 58 can be disposed within the interceptor 10 and within the effluent. In other embodiments, the second pump 58 does not have to be submersible nor does it have to be inverted. The second pump 58 sits atop a support 64 to dispose the inlet 60 in the correct location. In the illustrated embodiment, the inlet 60 is disposed approximately 2 inches below the static level 54. However, the distance between the inlet 60 and the static level 54 may be different, so long as the inlet 60 is disposed within a grease layer 50 when the interceptor 10 is full.

The second pump 58 also includes an outlet pipe 62. The outlet pipe 62 is a conduit to direct removed grease to its desired location, such as, for example, a grease container. The grease container or other desired location for the removed grease may be exterior to the interceptor 10.

Also disposed in the effluent separation chamber 48 is a waste level probe 56. The waste level probe 56 measures the thickness of the waste layer (i.e. grease layer 50). The waste level probe 56 may be any type such as, but not limited to, the ones described in U.S. Pat. Nos. 5,705,055, 6,423,213 and 6,776,900. The waste level probe 56 may also be capable of turning the second pump on and off depending of the level and thickness of the grease layer 50. This can be accomplished by logic within the waste level probe 56 or by logic separate from the waste level probe 56.

The second baffle 68 includes an opening at its bottom to allow clean water to flow therethrough and into a clean water chamber 66. The clean water chamber 66 includes an outlet 72 through which the clean water exits the interceptor 10. The outlet 72 is disposed on the upper portion of the exterior wall 78. The outlet 72 may, alternatively, be disposed on any other wall of the clean water chamber 66.

A dam 70 disposed around the outlet 72 sets the static level 54 and raises it above a lowest edge 74 of the outlet 72. Without the dam 70, the static level 54 would be set by the lowest edge 74 of the outlet 72 because water entering clean water chamber 66 would begin to exit through the outlet 72 as soon as the water level reached the lowest edge 74. Because of the dam 70, the water level must reach and flow over the upper edge 76 of the dam 70 before it is able to exit the interceptor 10 through the outlet 72. The static level 54, as a result, is set by upper edge 76 of the dam 70 which is above the lowest edge 74 of the outlet 72. Consequently, the interceptor 10 can hold a greater volume of effluent.

The dam 70, as illustrated, includes four walls and is attached to the exterior wall 78 of the interceptor 10. The dam 70 may be shaped in many different ways and does not have to be disposed on the exterior wall 78 of the interceptor 10. For example, the dam 70 may be a baffle, similar to the first baffle 46, but having an upper surface that is higher than the lowest edge 74 of the outlet 70.

The interceptor 10 is used to remove waste material from an effluent. An effluent is defined as any fluid containing at least one type of waste material therein. The waste material may be in the form of a liquid or solid. For the purposes of explanation, the effluent used to explain the operation of the illustrated interceptor 10 is considered to contain initially a mixture of water, grease and solid waste (such as pieces of food). The interceptor 10 removes the grease and solid waste from the effluent to allow clean water to exit therefrom.

Effluent enters the inlet pipe 12 where it is mixed with air from the vent 14. The air that is mixed in with the effluent attaches to the grease, helping to separate the grease from the water. The effluent flows through the inlet pipe 12 and is directed downward by an elbow 16 of the inlet pipe 12. After being directed downward by the elbow 16, the effluent flows into the inlet chamber 18 of the interceptor 10.

At this point, the effluent contains, for purposes of explanation, grease, water and solid material. The first pump 20 pumps the effluent located in the lower portion of the inlet chamber 18 through the conduit 24 to the solids removing chamber 22. The solids removing chamber 22 is located above the inlet chamber 18.

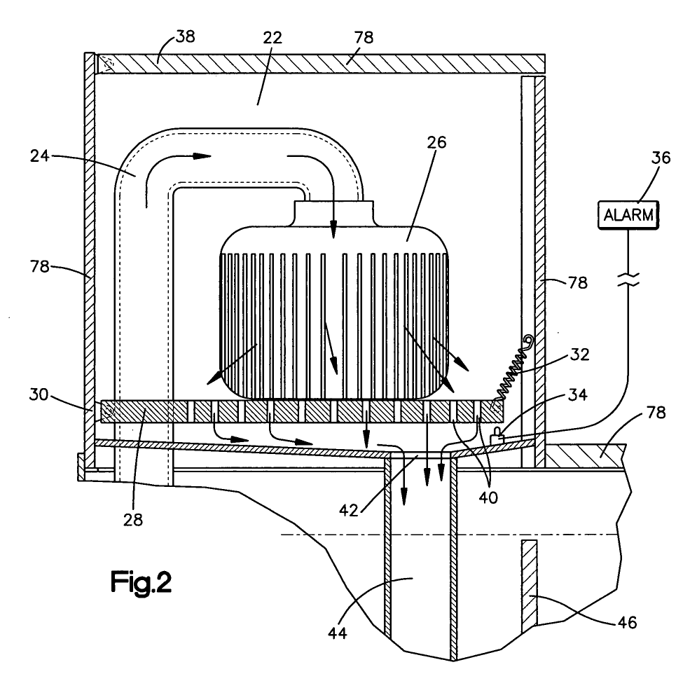

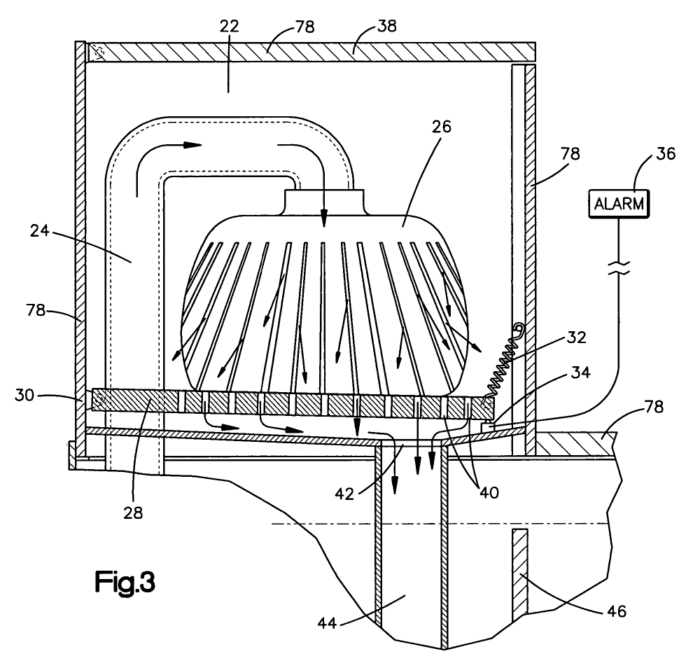

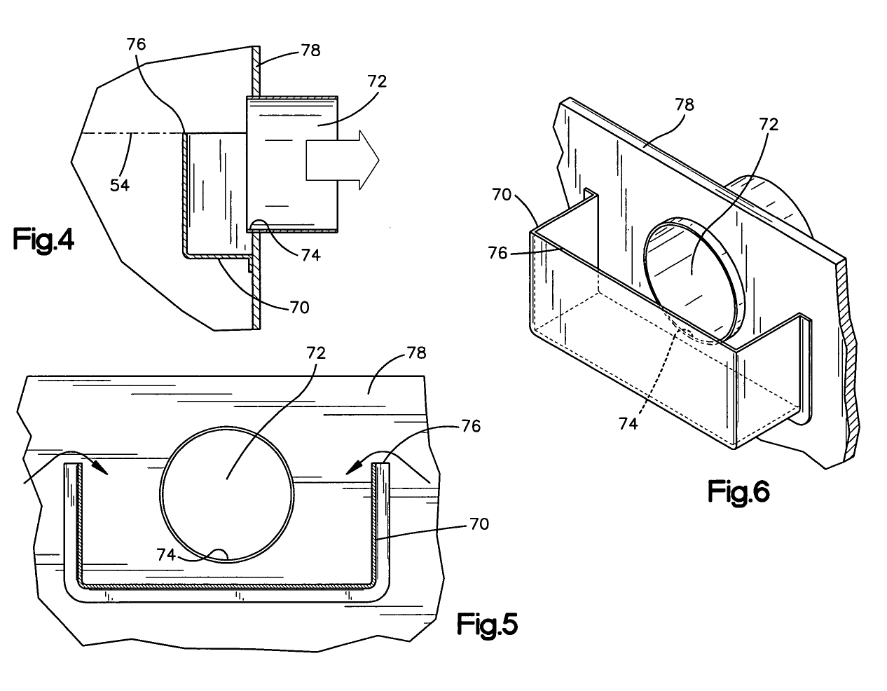

The effluent is pumped through the conduit 24 (FIGS. 2 and 3) and through the filter 26. The filter 26, in the illustrated embodiment, is a pliable disposable bag which allows the effluent to pass therethrough while catching the solid materials in the effluent. The solids materials remain in the filter 26. As more effluent passes through the filter 26, more solids materials remain in the filter 26. As the volume of solids materials increases, the weight of the filter 26 increases. The weight of the filter 26 pushes against the platform 28 that is disposed beneath the filter 26.

In the illustrated embodiment, the platform 28 is hingedly attached at one end to the side wall 30 of the solids removing chamber 22. The platform 28 is also attached at the other end to at least one spring 32. As the weight of the filter 26 increases, the filter 26 pushes against the platform 28 which causes the platform 28 to pivot about its hinged end. When the filter 26 is full as shown in FIG. 3, the weight of the filter 26 will cause the platform 28 to move far enough to contact the switch 34. The switch 34 causes an alarm 36 to be activated to indicate to a user that the filter 26 is full and needs to be changed or emptied.

To change or empty the filter 26, the lid 38 of the solids removing chamber 22 is opened to access the solids removing chamber 22. Specifically, the lid 38 is hinged to the side wall 30 at one end, thus allowing a user to swing the lid 38 open and replace the filter 26. Since the filter 26 is drained and sits in the solids removing chamber 22 which does not have standing effluent, the filter 26 is able to dry out and is friendlier to change as opposed to filters of previous designs which sit in a pool of effluent.

Effluent that passes through the filter 26 flows through the holes 40 in the platform 28 and into the drain 42 in the floor of the solids removing chamber 22. The drain 42 includes the drain duct 44 which runs from the floor of the solids removing chamber 22 to the lower portion of the inlet chamber 18. The effluent flows through the drain duct 44 and into the lower portion of the inlet chamber 18. The drain duct 44, in the illustrated embodiment, is in a corner diagonal from the corner that the first pump 20 is disposed. In that way, the flow of the effluent from the drain duct 44 will flush solids materials sitting near the bottom of the inlet chamber 18 towards the first pump 20.

The effluent fills the inlet chamber 18 until the level of effluent is higher than the first baffle 46. When the level of effluent in the inlet chamber 18 exceeds the height of the first baffle 46, the effluent flows over the first baffle 46 and into the effluent separation chamber 48.

In the effluent separation chamber 48, the grease, which is less dense, separates and floats on top of the water, which is more dense. This results in the fluid in the effluent separation chamber 48 having a layer of grease 50 (waste layer) floating on a body of water 52. The grease layer 50 floating on the body of water 52 has a thickness measured downward from the upper surface of the grease layer 50 to the boundary between the grease layer 50 and the body of water 52. In the embodiment illustrated in FIG. 1, the upper surface of the grease layer 50 is shown at the static level 54.

The thickness of the grease layer 50 is measured by the waste level probe 56. When the thickness of the grease layer 50 is approximately three inches, as determined by the probe 56, the second pump 58 is turned on. The second pump 58 has an inlet that is approximately two inches below the static level 54. The second pump 58 when turned on thus pumps out approximately two inches of grease from the grease layer 50. This can be accomplished for example by allowing the second pump 58 to operate for a predetermined amount of time which has been previously calibrated to remove approximately two inches of grease. The removed grease is pumped out of the effluent separation chamber 48 through the outlet pipe 62. The removed grease may be pumped to a grease container (not shown) exterior to the interceptor 10 which can be subsequently disposed of in the proper manner.

The body of clean water 52 continues to flow beneath the second baffle 68 into the clean water chamber 66. The clean water fills the clean water chamber 66 until it overflows the top surface of the dam 70. The clean water is prevented by the dam 70 of entering directly the outlet 72 of the interceptor 10. As stated above, the dam 70 prevents the clean water from flowing directly into the outlet 72 of the interceptor 10. This raises the static level 54.

By raising the static level 54, the amount of space used in the interceptor 10 is maximized. In other words, an interceptor 10 having a dam 70 which raises the static level 54 can hold a greater volume of effluent than an identical-sized interceptor that does not have such a dam 70. By adding a dam 70, an interceptor manufacturer can increase the capacity without increasing the size of the interceptor. This is important as interceptors are usually stored in relatively small spaces. In addition, the increased capacity provides a longer residence time for effluent in the interceptor 10, which can increase the separation efficiency.

The above description of some of the embodiments of the present invention has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

What is claimed is:

1. An interceptor comprising:
an effluent separation chamber operable to hold effluent; and
a submersible pump having an intake port,
wherein said submersible pump is disposed in said effluent separation chamber,
wherein said intake port is disposed below a static effluent level of said interceptor.

2. The interceptor of claim 1, further comprising a grease level probe disposed within said effluent separation chamber operable to turn said submersible pump on and off.

3. The interceptor of claim 1, further comprising a grease discharge conduit attached, at a first end, to an outlet port of said submersible pump and operable to remove grease from said effluent separation chamber.

4. The interceptor of claim 1, further comprising:
a clean water chamber; and
a baffle having a passage in a lower portion of said baffle;
wherein said baffle is disposed between said effluent separation chamber and said clean water chamber;
wherein said passage permits water to enter said clean water chamber from said effluent separation chamber.

5. An interceptor comprising:
an inlet chamber;
a solids removing chamber disposed above said inlet chamber, said solids removing chamber having a drain;
a pump operable to pump an effluent through a conduit from said inlet chamber to said solids removing chamber;
a filter connected to an end of said conduit in said solids removing chamber;
wherein said filtering device is operable to catch solid material in said effluent; and
wherein said drain is operable to permit effluent that has passed through said filtering device to return to said inlet chamber.

6. The interceptor of claim 5, further comprising an inlet having a vent, wherein said vent is operable to permit air to mix with said effluent before said effluent enters said inlet chamber.

7. The interceptor of claim 6, wherein said inlet includes an elbow operable to direct effluent entering said inlet chamber downward.

8. The interceptor of claim 5, wherein said solids removing chamber includes a movable platform operable to move as the filtering device becomes filled with solid material.

9. The interceptor of claim 8, wherein said solids removing chamber further includes a filter replacement indicating device which provides a signal when said movable platform has moved to a predetermined position.

10. The interceptor of claim 8, wherein said movable platform is pivotable about a first end of said movable platform and wherein said movable platform is supported by a urging member on a second end of said movable platform.

11. The interceptor of claim 5, wherein said solids removing chamber includes a filter access member which provides access to said filtering device and allows said filtering device to be removed from said solids removing chamber.

12. The interceptor of claim 5, further comprising a drain duct connected to said drain, wherein said drain duct directs effluent that has passed through said filtering device from said drain to a bottom portion of said inlet chamber.

13. The interceptor of claim 5, further comprising:
an effluent separation chamber; and
a baffle disposed between said inlet chamber and said effluent separation chamber;
wherein said baffle permits effluent to pass from said inlet chamber to said effluent separation chamber only when a level of the effluent in said inlet chamber is higher than said baffle.

14. The interceptor of claim 13, further comprising
a submersible pump having an intake port,
wherein said submersible pump is disposed in said effluent separation chamber, and
wherein said intake port is disposed within said effluent and below a static level of said effluent.

15. The interceptor of claim 14, further comprising:
an outlet having a lower surface;
a dam disposed within said interceptor;
wherein said dam raises a static level of an effluent within said interceptor above the lower surface of said outlet.

16. An interceptor comprising:
an outlet having a lower edge;
a dam disposed within said interceptor;
wherein said dam raises a static level of an effluent within said interceptor above the lower edge of said outlet.

17. The interceptor of claim 16, wherein said darn surrounds said outlet with two opposing side walls, a front wall which opposes said outlet and one bottom wall disposed below said outlet.

18. The interceptor of claim 16, wherein said dam is disposed in a clean water chamber of said interceptor.

19. The interceptor of claim 16, wherein said outlet is disposed on a wall of said interceptor and wherein said dam is attached to said wall.

20. The interceptor of claim 16, wherein a first baffle provides a common wall for an inlet chamber and an effluent separation chamber of said interceptor, said dam being higher than said first baffle.

21. An interceptor comprising:
an inlet chamber having an intake pipe, said intake pipe includes an elbow operable to direct effluent in said intake pipe downward towards a bottom surface of said inlet chamber;
a vent disposed in said intake pipe, said vent is operable to permit air to mix with said effluent before said effluent enters said inlet chamber;
a solids removing chamber above said inlet chamber, said solids removing chamber having a drain;
a first pump operable to pump an effluent in said inlet chamber through a conduit to said solids removing chamber;
a removable filter connected on an end of said conduit in said solids removing chamber;
a filter-full indicating device operable to indicate when said removable filter contains at least a predetermined amount of solids that have been filtered from said effluent;
an effluent separation chamber;
a first baffle disposed between said inlet chamber and said effluent separation chamber, said first baffle permits effluent to pass from said inlet chamber to said effluent separation chamber only when a level of said effluent in said inlet chamber is higher than said first baffle;
a second pump disposed in said separation chamber;
a waste level probe operable to selectively turn said second pump on and off depending on a thickness of a waste layer in said effluent;
an outlet having a lower edge;
a second baffle disposed between said outlet and said effluent separation chamber, said second baffle permits clean fluid to flow under said second baffle and towards said outlet;
a dam disposed within said interceptor, said dam raises a static effluent level above the lower edge of said outlet.
